(19) United States
(12) Patent Application Publication
(10) Pub. No.: US 2025/0056317 A1
(43) Pub. Date: Feb. 13, 2025

(54) APPARATUS AND METHOD FOR FORWARD ERROR CORRECTION PACKET SCHEDULING IN WIRELESS COMMUNICATION SYSTEM

(71) Applicant: Samsung Electronics Co., Ltd., Gyeonggi-do (KR)

(72) Inventors: Jaehyeon BAE, Gyeonggi-do (KR); Hyunkoo YANG, Gyeonggi-do (KR)

(21) Appl. No.: 18/799,001

(22) Filed: Aug. 9, 2024

(30) Foreign Application Priority Data
Aug. 10, 2023 (KR) 10-2023-0104854

(51) Int. Cl. H04W 28/04; H04L 1/00; H04W 28/24

(52) U.S. Cl. CPC H04W 28/04; H04L 1/0061; H04W 28/24

(57) ABSTRACT

The disclosure relates to a 5G or 6G communication system for supporting higher data rate. A method performed by an SMF in a communication system includes receiving, from a PCF, a PCC rule including a protocol descriptor that indicates support of a PDU set-based FEC, transmitting, to a UPF, packet handling information including detection rule information for distinguishing an FEC source packet and an FEC repair packet in the PDU set-based FEC, and transmitting, to an AMF, a QoS profile including a QoS rule updated based on the PCC rule.

### CROSS REFERENCE TO RELATED APPLICATION(S)

The present application claims priority under 35 U.S.C. § 119 (a) to Korean Patent Application No. 10-2023-0104854, which was filed in the Korean Intellectual Property Office on Aug. 10, 2023, the entire content of which is incorporated herein by reference.

### BACKGROUND

### 1. Field

The disclosure relates generally to the field of wireless communications, and more particularly, to a method and apparatus for creating information for processing protocol data units (PDUs) having the same characteristics as a set in which forward error correction (FEC) source and parity or repair packets are transmitted in a communication system using an FEC scheme.

### 2. Description of Related Art

Fifth generation (5G) mobile communication technologies define broad frequency bands such that high transmission rates and new services are possible and can be implemented not only in sub 6 gigahertz (GHz) bands such as 3.5 GHz, but also in above 6 GHz bands referred to as millimeter wave (mmWave) bands including 28 GHz and 39 GHz bands. In addition, it has been considered to implement 6G mobile communication technologies referred to as beyond 5G systems in terahertz (THz) bands, such as 95 GHz to 3 THz bands, to realize transmission rates fifty times faster than 5G mobile communication technologies and ultra-low latencies one-tenth of 5G mobile communication technologies.

Since the beginning of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, operating multiple subcarrier spacings for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for a large amount of data transmission and a polar code for highly reliable transmission of control information, layer 2 (L2) pre-processing, and network slicing for providing a dedicated network specialized to a specific service.

There are also ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

There is also ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access channel (2-step RACH) for simplifying NR random access procedures. There also has been ongoing standardization in system architecture/service regarding a 5G baseline architecture, such as a service based architecture or service based interface, for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The third generation partnership project (3GPP), which manages a cellular mobile communication standard, has introduced a new core network structure referred to as 5G core (5GC) and has been standardizing the 5GC to push evolution from a fourth generation long term evolution (4G LTE) system to a 5G system. 5GC supports many distinguishable functions, compared to an evolved packet core (EPC), which is a network core for 4G.

5GC adopts the network slicing function. As a requirement condition of 5G, 5GC should support various types of terminals and services, such as eMBB, URLLC, or mMTC. These UEs/services have different requirement conditions for the core network, respectively. For example, the eMBB service may require a high data rate while the URLLC service may require high stability and low latency. The network slicing technology has been provided to meet such various requirement conditions.

Network slicing indicates a method for creating several logical networks (e.g., network slices) by virtualizing one physical network. An activated network slice may be referred to as a network slice instance, and respective network slice instances (NSIs) may have a different characteristic. The mobile communication operator may meet various service requirement conditions according to the UE/service by constituting a network function (NF) fitting the characteristics of each NSI. For example, the mobile communication operator may allocate the NSI fitting the characteristics of the service required for each UE and efficiently support several 5G services (e.g., eMBB, URLLC, or mMTC).

The 5G system may seamlessly support the network virtualization paradigm through separation of the mobility management function and the session management function (SMF). In 4G LTE, all UEs may receive services over the network through signaling exchange with a single core entity referred to as a mobility management entity (MME) in charge of registration, authentication, mobility management and SMFs. In 5G, the number of UEs (including, e.g., MTC UEs) has exponentially increased and mobility and traffic/session characteristics that need to be supported according to the type of UE are subdivided. Accordingly, if all functions are supported by a single MME, the scalability of adding entities for each required function may decrease. Accordingly, various functions are under development based on a structure that separates the mobility management function and the SMF to enhance the scalability in terms of function/implementation complexity and signaling load of the core entity in charge of the control plane.

For metaverse and XR applications, since terminals must transmit a large amount of traffic through downlink (DL)/uplink (UL), effectively handling the traffic can be a critical technical issue, in contrast to conventional applications. Unlike previous research that has focused on how to effectively transmit DL traffic to terminals, with regard to metaverse/XR traffic, there is a need in the art for a method to effectively process DL traffic by considering the service characteristics of each packet.

### SUMMARY

The disclosure has been made to address the above-mentioned problems and disadvantages, and to provide at least the advantages described below.

Accordingly, an aspect of the disclosure is to provide methods and an apparatus for resolving congestion situations that occur during packet processing in a radio access network (RAN), by modifying how a scheduler performs a random packet drop.

An aspect of the disclosure is to provide a method and apparatus in which XR services may utilize traffic characteristic information currently provided by the service through the actual application function (AF) entity or application server (AS) when dropping packets.

An aspect of the disclosure is to provide a method for processing packets having the same characteristics in a specific unit (e.g., PDU set) and effectively processing the packets in consideration of the importance of the packets being serviced, such as when a network congestion situation occurs.

An aspect of the disclosure is to provide a method for recognizing and extracting real-time transport protocol (RTP) and network adaption layer (NAL) unit header information of actual data, distinguishing identical packets into PDU set units based on the corresponding information, creating PDU set information based on the extracted information or information received from the AS, and providing the distinguished packets to the RAN through GPRS tunnelling protocol (GTP)-U header to perform scheduling based on the corresponding information.

An aspect of the disclosure is to provide an apparatus and method for creating information for processing packets having the same characteristics by considering service traffic characteristics in a communication system may be provided.

An aspect of the disclosure is to provide a method and apparatus for supporting scheduling when a congestion situation occurs in a RAN of FEC source and repair packets based on a PDU set using an error correction code.

In accordance with an aspect of the disclosure, a method performed by an SMF in a communication system includes receiving, from a policy control function (PCF), a policy and charging control (PCC) rule including a protocol descriptor that indicates support of a PDU set-based FEC, transmitting, to a user plane function (UPF), packet handling information including detection rule information for distinguishing an FEC source packet and an FEC repair packet in the PDU set-based FEC, and transmitting, to an access and mobility management function (AMF), a quality of service (QOS) profile including a QoS rule updated based on the PCC rule.

In accordance with an aspect of the disclosure, a method performed by a UPF in a communication system includes receiving, from an SMF, a packet handling information including detection rule information for distinguishing an FEC source packet and a FEC repair packet in a PDU set, receiving, from an AS, DL data, and transmitting, to a RAN, information about whether a packet included in the DL data corresponds to any one of the FEC source packet and the FEC repair packet and association information between the FEC source packet and the FEC repair packet by including the information about whether a packet included in the DL data corresponds to any one of the FEC source packet and the FEC repair packet and the association information between the FEC source packet and the FEC repair packet in a general packet radio service (GPRS) tunneling protocol-user plane (GTP-U) header of each packet.

In accordance with an aspect of the disclosure, an SMF operating in a communication system includes a transceiver, and a controller configured to receive, from a PCF, a PCC rule including a protocol descriptor that indicates support of a PDU set-based FEC, transmit, to a UPF, packet handling information including detection rule information that distinguishes FEC source packets and FEC repair packets in the PDU set-based FEC, and transmit, to an AMF, a QoS profile including a QoS rule updated based on the PCC rule.

In accordance with an aspect of the disclosure, a UPF operating in a communication system includes a transceiver, and a controller configured to receive, from an SMF, a packet handling information including detection rule information for distinguishing a forward error correction (FEC) source packet and a FEC repair packet in a PDU set, receive, from an AS, DL data, and transmit, to a RAN, information about whether a packet included in the DL data corresponds to any one of the FEC source packet and the FEC repair packet and association information between the FEC source packet and the FEC repair packet by including the information about whether a packet included in the DL data corresponds to any one of the FEC source packet and the FEC repair packet and the association information between the FEC source packet and the FEC repair packet in a GTP-U header of each packet.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a network structure and interfaces of a 5G system according to an embodiment;

FIG. 2 illustrates an operation for performing RAN scheduling based on PDU set handling for FEC sources and FEC repair packets generated using an FEC scheme within a single service floor in a wireless communication system according to an embodiment;

FIG. 3 illustrates an operation for buffering FEC repair packets performed based on congestion occurrence notification information during service use using an FEC scheme per PDU set in a wireless communication system according to an embodiment;

FIGS. 4A and 4B illustrate a method for transferring information for supporting scheduling for a service that transmits a packet created based on FEC using a protocol description including FEC-based packet creation support information transferred through AF in a wireless communication system according to an embodiment;

FIGS. 5A and 5B illustrate a method for supporting RAN scheduling operation according to a RAN congestion situation during service use using a PDU set-based FEC scheme in a wireless communication system according to an embodiment;

FIG. 6 illustrates a structure of a UE according to an embodiment; and

FIG. 7 illustrates a structure of a network entity according to an embodiment.

### DETAILED DESCRIPTION

Hereinafter, an embodiment of the disclosure is described in detail with reference to the accompanying drawings, in which the same or similar elements are preferably denoted by the same or similar reference numerals. Detailed descriptions of known functions or configurations that may make the subject matter of the disclosure unclear will be omitted for the sake of clarity and conciseness.

The terms to be described below are defined considering a function in the disclosure and may be replaced with other terms according to the intention or practice of the user or operator. Therefore, the terms should be defined based on the content of the disclosure.

Similarly, some elements in the drawings are exaggerated, omitted, or schematically illustrated. Also, actual sizes of respective elements are not necessarily represented in the drawings. In the drawings, the same or corresponding elements are denoted by the same reference numerals.

An element included in the disclosure is expressed in the singular or the plural according to presented embodiments of the disclosure. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Hereinafter, a base station (BS) may be an entity performing allocating a resource to a UE and may be at least one of a gNode B, an eNode B, a Node B (or xNode B (here, x denotes an alphabet including g and e)), a wireless access unit, a BS controller, a satellite, an air vehicle (airborn), and a node on a network. A terminal (UE) may include a mobile station (MS), a vehicular, a satellite, an air vehicle (airborn), a cellular phone, a smartphone, computer, or a multimedia system capable of performing a communication function. In the disclosure, a DL is a wireless transmission path of a signal transmitted, from a BS, to a UE, and a UL is a wireless transmission path of a signal transmitted from a UE to a BS. Additionally, there may be a sidelink (SL) meaning a wireless transmission path of a signal transmitted by a UE to another UE.

In addition, although LTE, LTE-advanced (LTE-A), or 5G systems may be described below as an example, an embodiment of the disclosure may be applied to other communication systems having a similar technical background or channel type. For example, 5G-advance, NR-advance or 6G developed after a 5G mobile communication technology or NR) may be included therein, and 5G may be a concept which includes existing LTE, LTE-A and other similar services. The disclosure may be applied to other communication systems through some modifications within a range which does not significantly depart from the scope of the disclosure as judged by a person having skilled technical knowledge.

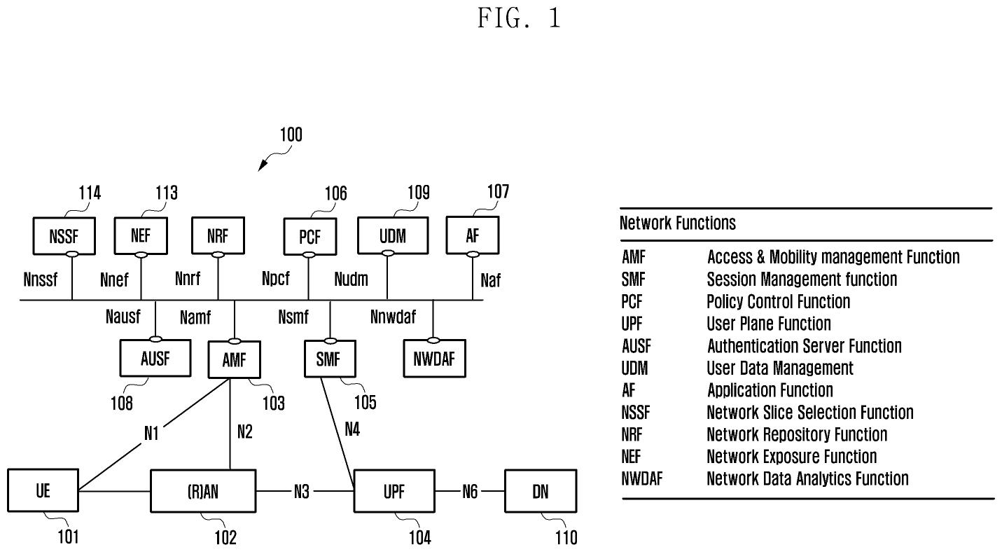

FIG. 1 illustrates a network structure and interfaces of a 5G system according to an embodiment.

Referring to FIG. 1, a network entity included in the network structure of the 5G system 100 may include an NF according to system implementation.

Referring to FIG. 1, the network structure of the 5G system 100 may include various network entities, such as an authentication server function (AUSF) entity 108, an AMF entity 103, an SMF entity 105, a PCF entity 106, an AF entity 107, a unified data management (UDM) entity 109, a data network (DN) 110, a network exposure function (NEF) entity 113, a network slicing selection function (NSSF) entity 114, an edge application service domain repository (EDR), an edge AS (EAS), an EAS discovery function (EASDF), a UPF entity 104, a RAN 102, and a terminal such as a UE 101.

The respective NF entities of the 5G system 100 may support the following functions.

The AUSF 108 may process and store data for authentication of the UE 101.

The AMF 103 may provide a function for access and mobility management in a unit of UE, and one UE may be basically connected to one AMF. More specifically, the AMF 103 may support functions such as inter-CN node signaling for mobility between 3GPP access networks, termination of a RAN CP interface (i.e., an N2 interface), a termination (N1) of non-access stratum (NAS) signaling, NAS signaling security (NAS ciphering and integrity protection), AS security control, registration management (registration area management), connection management, idle mode UE reachability (including control and performance of paging retransmission), mobility management control (e.g., subscription and policies), support of intra-system mobility and inter-system mobility, support of network slicing, SMF selection, lawful interception (for an AMF event and an interface for an LI system), provision of transfer of session management (SM) messages between the UE and the SMF, a transparent proxy for routing SM messages, access authentication, access authorization including a roaming right check, provision of transfer of SMS messages between the UE and the SMSF, a security anchor function (SAF), and/or a security context management (SCM). Some or all functions of the AMF entity 103 may be supported in a single instance of one AMF entity.

The DN 110 indicates an operator service, an Internet access or 3rd party service, etc. The DN 110 may transmit a DL PDU to the UPF entity 104, or receive a PDU transmitted from the UE 101 from the UPF entity 104.

The PCF entity 106 may receive information on a packet flow from an AS, to provide a function of determining a policy such as mobility management, session management, etc. Specifically, the PCF entity 106 may support a function, such as support of a unified policy framework for controlling network operation, provision of a policy rule to enable control plane function entity(s) (e.g., the AMF entity 103, the SMF entity, etc.) to execute the policy rule, and implementation of a front end (FE) for accessing relevant subscription information for policy determination in a user data repository (UDR).

The SMF entity 105 may provide an SMF, and when the UE 101 has multiple sessions, the respective sessions may be managed by different SMF entities. Specifically, the SMF entity 105 may support a function, such as session management (e.g., session establishment, modification, and release, including tunnel maintenance between the nodes of the UPF entity 140 and the (R)AN 102), UE IP address allocation and management (including selective authentication), selection and control of a UP function, configuration of traffic steering at the UPF entity 104 to route traffic to a proper destination, termination of interfaces towards PCFs, execution of a control part of a policy and a QoS, lawful intercept (for an SM event and an interface to an LI system), termination of SM parts of NAS messages, DL data notification, an initiator of AN-specific SM information (transferred to the (R)AN 102 through N2 via the AMF entity 103), determination of a session and service continuity (SSC) mode of a session, and a roaming function. Some or all functions of the SMF entity 105 may be supported in a single instance of one SMF entity.

The UDM entity 109 may store user subscription data, policy data, etc. The UDM entity 109 may include two parts, i.e., an application FE and a UDR.

The FE may include a UDM FE in charge of location management, subscription management, and credential processing, and a PCF entity in charge of policy control. The UDR stores data required for functions provided by the UDM-FE, and a policy profile required by the PCF entity. The data stored in the UDR includes a subscription identifier, a security credential, user subscription data including access and mobility-related subscription data and session-related subscription data, and policy data. The UDM-FE accesses subscription information stored in the UDR, and supports a function such as authentication credential processing, user identification handling, access authentication, registration/mobility management, subscription management, and SMS management.

The UPF entity 104 transfers a DL PDU received from the DN 110 to the UE 101 via the (R)AN 102, and transfers, to the DN 110, a UL PDU received from the UE 101 via the (R)AN 102. Specifically, the UPF entity 104 may support a function, such as an anchor point for intra/inter-RAT mobility, an external PDU session point of interconnection to a data network, packet routing and forwarding, packet inspection and a user plane part of policy rule enforcement, lawful intercept, traffic usage reporting, a UL classifier for supporting to route traffic flows to a data network, a branching point for supporting a multi-homed PDU session, QoS handling for a user plane (e.g., packet filtering, gating, and UL/DL rate enforcement), UL traffic verification (a service data flow (SDF) mapping between an SDF and a QoS flow), transport level packet marking in UL and DL, a DL packet buffering, and DL data notification triggering function. Some or all functions of the UPF entity 104 may be supported in a single instance of one UPF.

The AF entity 107 interacts with a 3GPP core network for service provision (e.g., supporting of a function, such as application influence on traffic routing, access to network capability exposure, and interaction with a policy framework for policy control).

The (R)AN 102 supports both an evolved E-UTRA that is an evolved version of a 4G radio access technology, and an NR access technology, such as a gNB.

The gNB may support a function, such as functions for radio resource management (i.e., radio bearer control, radio admission control, connection mobility control, and dynamic allocation of resources to the UE in UL/DL (i.e., scheduling)), IP header compression, encryption and integrity protection of a user data stream, selection of the AMF at UE attachment when no routing towards the AMF is determined from the information provided by the UE, routing of user plane data to the UPF(s), routing of control plane information to the AMF, connection setup and release, scheduling and transmission of paging messages generated from the AMF, scheduling and transmission of system broadcast information (generated from the AMF or operating and maintenance (O&M)), measurement and measurement reporting configuration for mobility and scheduling, transport level packet marking in UL, session management, support of network slicing, QoS flow management and mapping to a data radio bearer, support of the UE in an inactive mode, a NAS message distribution function, a NAS node selection function, sharing of a RAN, dual connectivity, and tight interworking between NR and E-UTRA.

The UE 101 may indicate a user device. The UE may be a terminal, mobile equipment (ME), a mobile station (MS), and the like. In addition, the UE may be a portable device, such as a notebook, a mobile phone, a personal digital assistant (PDA), a smartphone, or a multimedia device, or an unportable device such as a personal computer (PC) or a vehicle-mounted device.

The NEF 111 provides a functionality for securely exposing services and capabilities provided by 3GPP NFs, e.g., for a 3rd party, internal exposure/re-exposure, AF, and edge computing. The NEF 111 may receive information (based on exposed capability(s) of other NF(s)) from the other NF(s). The NEF 111 may store received information as structured data by using a standardized interface as a data storage NF. The stored information may be re-exposed to other NF entity(s) and AF entity(s) by the NEF entity 111 and may be used for other purposes such as analysis.

The EASDF 112 is an NF that is capable of adding, for each FQDN, an address of a DNS server to which a DNS request of the UE is to be forwarded, and an ECS option representable by an IP subnet address required to be added when the DNS request of the UE is forwarded. The EASDF 112 receives EAS domain configuration information from the EDR 113 and performs the processing for a DNS request message received from the UE, according to the received information. In addition, the EASDF 112 is an NF that performs a function of receiving, from the SMF 105, a UE IP address, location information of the UE in 3GPP, a DNS message handling rule, and a DNS message reporting rule, handling a DNS query message received from the UE and a DNS response message received from a DNS server, and transmitting, according to the DNS message reporting rule, information in a DNS message and statistical information obtained by processing the same to the SMF 105.

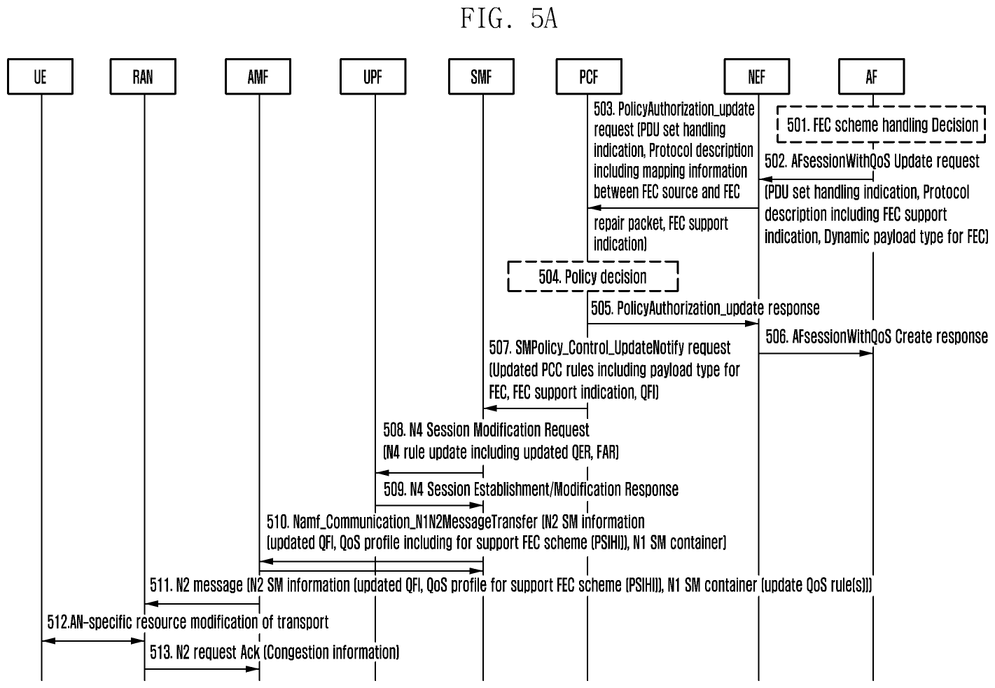

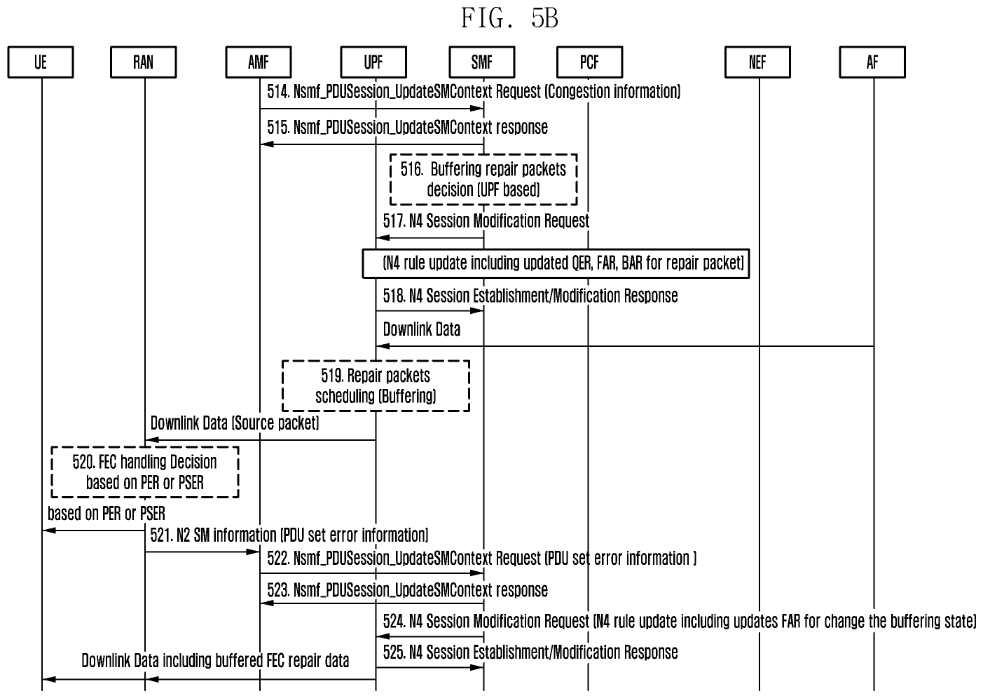

It is noted that all NFs illustrated in the method of FIGS. 5A and 5B described below may interact with the NRF as needed.

The NRF supports a service discovery function. The NRF receives an NF discovery request from an NF instance and provides information of discovered NF instances to the NF instance. In addition, the NRF maintains available NF instances and services supported thereby.

An instance when the UE 101 accesses the one DN 110 by using one PDU session is illustrated in FIG. 1 as an example for convenience of explanation, but the disclosure is not limited thereto.

The UE 101 may concurrently access two (i.e., local and central) data networks by using multiple PDU sessions. Here, two SMFs may be selected for different PDU sessions. However, each SMF may have a capability of controlling both a local UPF and a central UPF in a PDU session

In addition, the UE 101 may concurrently access two (i.e., local and central) data networks provided in a single PDU session.

In a 3GPP system, a conceptual link connecting NFs in a 5G system may be defined as a reference point. For example, reference point(s) included in the 5G system of FIG. 1 include the following reference point(s).
N1: A reference point between the UE 101 the AMF 103
N2: A reference point between the (R)AN 102 and the AMF 103
N3: A reference point between the (R)AN 102 and the UPF 104
N4: A reference point between the SMF 105 and the UPF 104
N5: A reference point between the PCF 106 and the AF 107
N6: A reference point between the UPF 104 and the DN 110
N7: A reference point between the SMF 105 and the PCF 106
N8: A reference point between the UDM 109 and the AMF 103
N10: A reference point between the UDM 109 and the SMF 105
N11: A reference point between the AMF 103 and the SMF 105
N12: A reference point between the AMF 103 and the AUSF 108
N13: A reference point between the UDM 109 and the AUSF 108
N14: A reference point between two AMFs 103
N15: In a non-roaming scenario, a reference point between the PCF and the AMF, and in a roaming scenario, a reference point between the AMF and the PCF in a visited network
Nx: A reference point between the SMF 105 and an EASDF 112
Ny: A reference point between the NEF (EDF) 111 and an EASDF 112

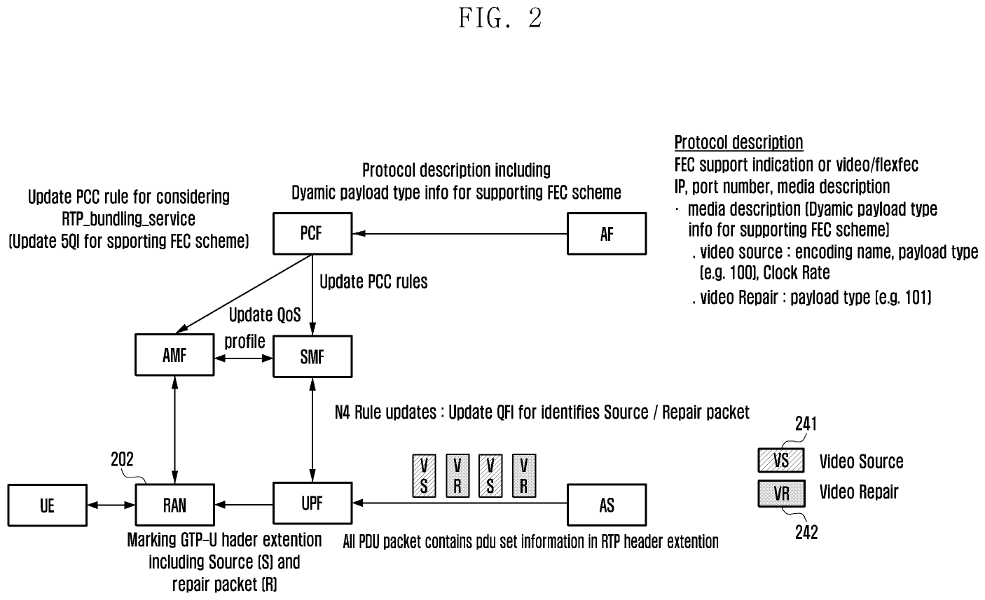

FIG. 2 illustrates an operation for performing RAN 202 scheduling based on PDU set handling for FEC source and FEC repair packets created using an FEC scheme within a single service floor in a wireless communication system according to an embodiment.

Referring to FIG. 2, a real-time communication service may use FEC to restore lost media data. As an example of the FEC scheme, a single parity-check code may be utilized. An FEC source packet is to be protected using FEC and may be an RTP packet including media data. An FEC repair packet includes repair data required to restore a lost FEC source packet and may be an RTP packet including repair data, such a video source 241 and video repair 242 data, and an FEC header. The repair data is created by an algorithm referred to as an FEC code, and the FEC code may be a single parity-check code. For convenience of explanation, a single parity-check code scheme that creates one FEC repair packet using K FEC source packets may be described as an example, but a FEC code scheme in the disclosure is not limited thereto. In this case, a set of FEC source packets to which FEC is applied is referred to as an FEC source packet block.

In the FEC scheme herein, an FEC source packet block may be constituted in units of PDU sets. For example, an FEC source packet block for each FEC repair packet may be constituted with all or part of the FEC source packets included in one or two or more PDU sets transmitted via a single RTP stream, such as the video source 241 and video repair 242 blocks in FIG. 2. As another example, an FEC source packet block for each FEC repair packet may be constituted with all or part of the FEC source packets belonging to one or more PDU sets transmitted via two or more RTP streams. The mapping relationship between the FEC source packet block and the PDU set may be included in a protocol descriptor transferred from the AF 207. Herein, the term protocol descriptor may be used in the same manner as the term protocol description. The identifier of the PDU set associated with the FEC source packet block may be signaled through the RTP extension header of the FEC repair packet.

In FIG. 2, the AF 207 may create a protocol descriptor including at least some of the information, such as PDU set handling and FEC support indication or FEC handling indication, payload type of FEC repair packet created using FEC scheme in a service floor (e.g., FlexFEC etc.), mapping information of FEC source packet(s) related to FEC repair packet per PDU set (mapping information of source and repair packet per PDU set) to request a service using PDU set-based FEC scheme of the corresponding service floor, and transfer the protocol descriptor to the PCF 206.

The PCF 206 determines whether to accept a service request using the corresponding PDU set-based FEC scheme based on the protocol descriptor including the indication and related information for the service utilizing the PDU set handling and FEC scheme transferred from the AF 207. When the corresponding service request is acceptable, the PCF 206 may perform a PCC rule creation/update operation including the indication and related service requirement information for utilizing the PDU set handling and FEC scheme transferred from the AF 207 and transfer the updated policy information to the SMF 205. When the corresponding service floor cannot support the service utilizing the FEC scheme based on the service requirement transferred from the AF 207, the PCF 206 may transfer a rejection message for the corresponding request to the AF 207 through a response to the AF 207 requirement related message.

If the PCF 206 determines to provide packets in PDU set units using the FEC scheme, the PCF 206 may recognize, through the PDU set handling indication and FEC scheme support indication or FEC handling indication transferred from the AF 207, that packets in the corresponding service floor have been created using the PDU set-based FEC scheme, and to support this, the PCF 206 may create the PDU set QoS profile of packets transferred in the service floor based on the protocol descriptor or predefined information and include the created PDU set QoS profile when creating or updating the PCC rule.

When there is no FEC support indication or FEC handling indication indicating that the FEC scheme is applied separately for each PDU set in the protocol description transferred to the AF 207, the FEC scheme may not be provided for packets in the corresponding service floor. When there is no separate indication that may distinguish the FEC source and FEC repair packet in the PDU set information transferred from the AS through an extension header, the corresponding information is recognized by the UPF 204 and the UPF 204 may mark the corresponding information in the GTP-U extension header. For example, when the corresponding information is the FEC source packet and is an FEC repair packet as Source(S), the UPF 204 may mark the information as Repair (R) or assign 2 separate bits to indicate the use of FEC schemes, and include the information on the distinguishment of packets in the service floor using FEC schemes in the GTP-U extended header and transfer the same to the RAN 202.

The PCF 206 may transfer, to the SMF 205, a PCC rule including the PDU set QoS profile and updated QoS information for supporting the service using the FEC scheme per PDU set in a RAN 202, the protocol descriptor information including the mapping information of the FEC source packets related to the FEC repair packets of the packets to which the corresponding FEC scheme per PDU set is applied in the UPF 204, and the like. The source FEC packets for one FEC repair packet may be constituted with all or part of the FEC source packets belonging to one or more PDU sets.

The SMF 205 may create updated QFI and QoS rule, SDF template, etc. using the QoS information of the service floor using the FEC scheme per the PDU set, based on the PCC rule transferred from the PCF 206, and transfer the created updated QFI and QoS rule to the RAN 202 and UPF 204. The SMF 205 may transfer information for packet scheduling per PDU set to the RAN 202, based on the PDU set QoS profile and QFI, QoS rule, QoS profile, etc. transferred through the PCC rule. Such information may be transferred to the RAN 202 via the AMF 203. In addition, the SMF 205 may transfer, to the UPF 204, information regarding whether the updated QFI value and PDU set information in the packet detection rule (PDR) of the service floor are transferred from the AS through the N4 rule update, and information on a rule for including packet-related PDU set information utilizing the corresponding FEC scheme per PDU set in the GTP-U header confirmation field, or the like.

When a service floor applying the FEC scheme per PDU set is input thereafter, the UPF 204 may extract the PDU set information from the packet extension header and include the same in the GTP-U header confirmation field, or if it is not included in the packet extension header, the UPF 204 may create related information and transfer the same to the RAN 202.

Based on the PDU set information including the PDU set QoS profile and the FEC source packet and FEC repair packet distinguishment information transferred in the above operation, the RAN 202 may perform scheduling operations for packets in the QoS floor to which the FEC scheme has been applied in the event of a congestion situation on a PDU set unit. For example, when a congestion situation occurs in the RAN 202 and no separate PER or PSER is measured, the RAN 202 may perform scheduling by dropping FEC repair packets first.

The UE 201 may receive the FEC source packets and FEC repair packets from the RAN 202 and obtain media data by utilizing the FEC scheme.

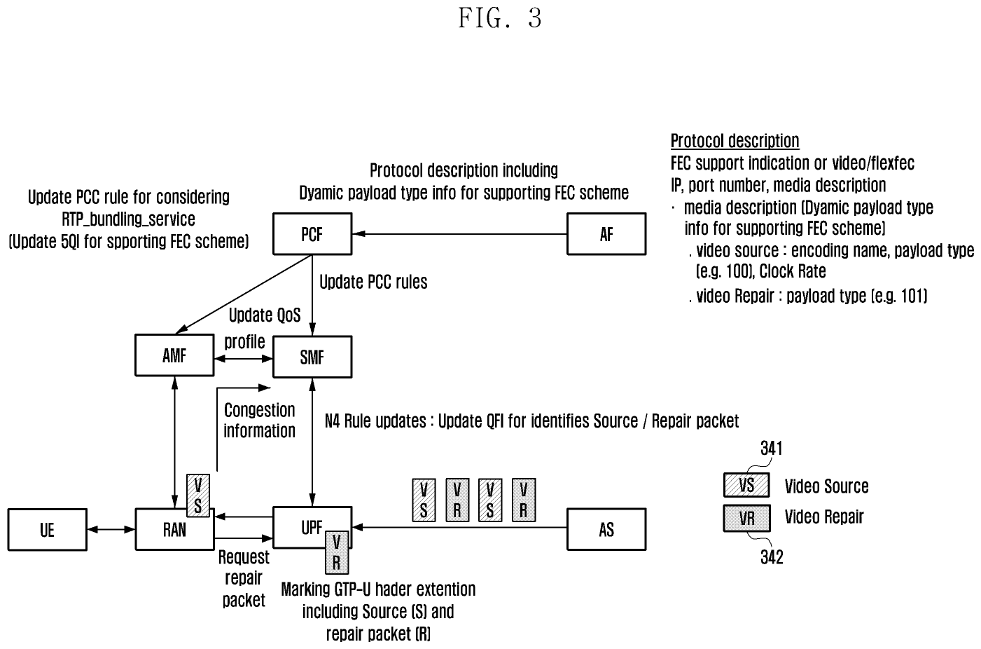

FIG. 3 illustrates a buffering operation of an FEC repair packet performed based on congestion occurrence notification information during service use using an FEC scheme per PDU set in a wireless communication system according to an embodiment.

Referring to FIG. 3, a real-time communication service may use FEC to restore lost media data. As an example of the FEC scheme, a single parity-check code may be utilized. An FEC source packet is to be protected by using FEC and may be an RTP packet including media data. An FEC repair packet is including repair data required to restore a lost FEC source packet and may be an RTP packet including repair data and an FEC header. The repair data is created by an algorithm referred to as an FEC code, and the FEC code may be a single parity-check code. For the convenience of explanation, a single parity check code scheme that creates one FEC repair packet using K FEC source packets may be described as an example, but the FEC code scheme in the disclosure is not limited thereto. In this case, a set of FEC source packets to which FEC is applied is called an FEC source packet block.

In the disclosed FEC scheme, an FEC source packet block may be constituted in units of PDU sets. For example, an FEC source packet block for each FEC repair packet may be constituted with all or part of the FEC source packets included in one or two or more PDU sets transmitted via a single RTP stream, such as the video source 341 and video repair 342 blocks in FIG. 3. As another example, an FEC source packet block for each FEC repair packet may be constituted with all or part of the FEC source packets belonging to one or more PDU sets transmitted via two or more RTP streams. The mapping relationship between the FEC source packet block and the PDU set may be included in a protocol descriptor transferred from the AF entity 307. The identifier of the PDU Set associated with the FEC source packet block may be signaled via the RTP extension header of the FEC repair packet.

In FIG. 3, the AF entity 307 may create a protocol descriptor including at least a portion of the following information, to request a service utilizing an FEC scheme based on a PDU set of the corresponding service floor: PDU set handling and FEC support indication or FEC handling indication, a payload type of an FEC repair packet created using the FEC scheme within the service floor (e.g., FlexFEC etc.), mapping information of FEC source packet(s) related to FEC repair packets per PDU set (mapping information of source and repair packet per PDU set), and transfer the protocol descriptor to the PCF entity 306.

The PCF entity 306 determines whether to accept a service request utilizing the corresponding PDU set-based FEC scheme, based on the protocol descriptor including the indication for a service utilizing PDU set handling and FEC schemes transferred from the AF entity 307 and related information, and then, when the corresponding service request is acceptable, the PCF entity 306 may perform a PCC rule creation/update operation including the indication for utilizing the PDU set handling and FEC scheme transferred from the AF entity 307 and related service requirement information, and transfer updated policy information to the SMF 305. When the corresponding service floor cannot support the service utilizing the FEC scheme based on the service requirement transferred from the AF entity 307, the PCF entity 306 may transfer a rejection message for the corresponding request to the AF entity 307 through a response to the AF entity 307 requirement related message.

If the PCF entity 306 determines to provide packets in PDU set units using the FEC scheme, the PCF entity 306 may recognize, through the PDU set handling indication and FEC scheme support indication or FEC handling indication transferred from the AF entity 307, that packets in the corresponding service floor have been created using the PDU set-based FEC scheme, and to support this, the PCF entity 306 may create the PDU set QoS profile of packets transferred in the service floor based on the protocol descriptor or predefined information and include the created PDU set QoS profile when creating or updating the PCC rule.

When there is no FEC support indication or FEC handling indication indicating that the FEC scheme is applied separately for each PDU set in the protocol description transferred to the AF entity 307, the FEC scheme may not be provided for packets in the corresponding service floor. In addition, when there is no separate indication that may distinguish the FEC source and FEC repair packet in the PDU set information transferred from the AS through an extension header, the corresponding information is recognized by the UPF entity 304 and the UPF entity 304 may mark the corresponding information in the GTP-U extension header.

The PCF entity 306 may transfer, to the SMF 305, a PCC rule including the PDU set Qos profile and updated QoS information for supporting the service using the FEC scheme per PDU set in an RAN, the protocol descriptor information including the mapping information of the FEC source packets related to the FEC repair packets of the packets to which the corresponding FEC scheme per PDU set is applied in the UPF entity 304, and the like. The source FEC packets for one FEC repair packet may be constituted with all or part of the FEC source packets belonging to one or more PDU sets.

The SMF 305 may create updated QFI and QoS rule, SDF template, etc. using the QoS information of the service floor using the FEC scheme per the PDU set, based on the PCC rule transferred from the PCF entity 306, and transfer the created updated QFI and QoS rule to the RAN 302 and UPF entity 304. The SMF 305 may transmit information for packet scheduling per PDU set to the RAN, based on the PDU set QoS profile and QFI, QoS rule, QoS profile, etc. transferred through the PCC rule. Such information may be transferred to the RAN 302 via the AMF 303. In addition, the SMF 305 may transfer, to the UPF entity 304, information regarding whether the updated QFI value and PDU set information in the packet detection rule (PDR) of the service floor are transferred from the AS through the N4 rule update, and information on a rule for including packet-related PDU set information utilizing the corresponding FEC scheme per PDU set in the GTP-U header confirmation field, or the like.

When a service floor applying the FEC scheme per PDU set is input thereafter, the UPF entity 304 may extract the PDU set information from the packet extension header and include the same in the GTP-U header confirmation field, or if some of the PDU set information, such as FEC source packet and FEC repair packet distinguishment information, is not included in the packet extension header, the UPF entity 304 may create related information and transfer the same to the RAN.

In the RAN 302, based on the PDU set information including the PDU set QoS profile and the FEC source packet and FEC repair packet distinguishment information transferred in the above operation, the RAN 302 may perform a scheduling operation for packets in the QoS floor to which the FEC scheme is applied on a PDU set unit when a congestion situation occurs. For example, in the case of a congestion situation, the RAN 302 may perform RAN scheduling by distinguishing the priorities of packets based on the distinguishment information of the FEC source packet and FEC repair packet in the GTP-U extension header transferred from the UPF entity 304 and the PDU set information, and then first dropping the FEC repair packets linked to the FEC source packet of the corresponding PDU set.

As described above, during the service using the FEC scheme, the SMF 305 may recognize the occurrence of a congestion situation in the RAN 302 through QoS monitoring reporting of congestion information monitoring values, etc. from the RAN 302 or UPF entity 304. In addition, separate congestion information may be transferred to the SMF 305 through the UPF entity 304. In this manner, when the SMF 305 recognizes the occurrence of a congestion situation in the RAN, the SMF 305 may determine the buffering operation of the FEC repair packet based on the corresponding congestion information. The requirement for the QoS monitoring operation for congestion information monitoring may be included in the FEC-based service requirement determined by the AF entity 307. Accordingly, the PCF entity 306 may include the QoS monitoring requirement information for congestion information monitoring when creating or updating the PCC rule. In addition, the SMF 305 may receive the reporting threshold of the congestion information monitoring value, etc. through the AF entity 307 when performing QoS monitoring of the QoS floor using the FEC scheme, and may determine the QoS monitoring requirement of the QoS floor using the corresponding FEC scheme according to the policy of the network operator. The SMF 305 may perform QoS monitoring operation of a specific QoS floor by including such QoS monitoring requirements in the PCC rule and transferring the same to the RAN 302 or UPF entity 304. In addition, the QoS monitoring requirements may include information indicating the SMF 305 to transfer corresponding QoS monitoring reporting value to the PCF entity 306 for use in the PCF entity 306, and the PCF entity 306 may receive the corresponding QoS monitoring reporting value when it is transferred to the SMF 305 through a separate policy control reporting trigger (PCRT).

If the SMF 305 does not have information on whether the RAN 302 or UPF entity 304 supports scheduling or buffering of the corresponding FEC repair packet after receiving the PCC rule including the indication supporting the FEC scheme, the SMF 305 may request the RAN 302 for information on whether the corresponding scheduling or buffering service is supported by using the time FEC scheme support indication included in the N2 message. Through the N2 message response, the SMF 305 may be informed whether the RAN 302 supports scheduling or buffering of the FEC repair packet for scheduling the FEC source packet and FEC repair packet using the corresponding FEC scheme. When it is identified through the above process that the RAN 302 does not support scheduling or buffering of the FEC repair packet, the SMF 305 may determine that the buffering operation of the FEC repair packet is performed at the UPF entity 304 or SMF 305 when it recognizes or determines that a congestion situation has occurred at the RAN 302 based on the QoS monitoring reporting or a separate congestion situation notification message. When the RAN 302 supports separate scheduling or buffering, the SMF 305 may not perform a separate N4 rule update. As shown in FIG. 2, the UPF entity 304 may include the distinguishment information of the FEC source and repair packets in the PDU set information and transfer the same to the RAN 302 through the GTP-U extension header. Based on the PDU set information transferred from the UPF entity 304 through the GTP-U confirmation header, the RAN 302 determines the priority between PDU sets in the occurrence of congestion situation, and schedules and transmits FEC source packets among the packets in the PDU set that use the FEC scheme with the same priority. In the case of an FEC repair packet, the RAN 302 may determine whether to transmit the FEC repair packet to the UE or drop the FEC repair packet depending on whether an error occurs in the FEC source packet in the RAN 302 or UE (e.g., PER or PSER, etc.) through separate buffering.

When the SMF 305 receives information that the RAN 302 does not support buffering or scheduling of separate FEC repair packets, the SMF 305 may determine the buffering operation of the FEC repair packets based on QoS monitoring reporting or separate congestion information. When the SMF 305 determines a separate buffering operation for the FEC repair packets according to the congestion situation of the RAN 302 102 in the UPF entity 304, the SMF 305 may support the buffering of the FEC repair packets performed in the UPF entity 304 by adding forwarding action rule (FAR) information to buffering action rule (BAR) information of the corresponding PDR through an N4 rule change message.

Thereafter, the SMF 305 may transfer packet mapping information using the FEC scheme per PDU set including the FEC support indication, etc., and the updated QoS profile and QFI value to the RAN 302 through an N2 message.

When the RAN 302 or UE recognizes that an error occurs when receiving an FEC source packet, THE RAN 302 may include an FEC repair packet request including the corresponding PDU set information of the packet in which the error has occurred in the N2 SM information message and transfer the same to the SMF 305 through the AMF 303.

The SMF 305 that has received the corresponding FEC repair packet transmission request may directly transfer, to UPF entity 304, the FEC repair packet request message transferred through N4 rule update, or transfer, to the UPF entity 304, the FEC repair packet information related to the PDU set in which the packet error has occurred based on the mapping information of the FEC source packet and FEC repair packet in the protocol description of the PCC rule transferred from the PCF entity 306.

The UPF entity 304 that has received the FEC repair packet related information may transfer, to the RAN, the FEC repair packet related to the corresponding PDU set in which the error has occurred among the buffered FEC repair packets.

Specifically, the SMF 305 may determine to discard the FEC repair packet if the transmission of the FEC source packet related to the FEC repair packet has been completed in the RAN 302 for scheduling processing, based on the mapping information of the FEC source packet and FEC repair packet in the protocol description within the PCC rule. Alternatively, when an error occurs during transmission of the FEC source packet related to the FEC repair packet being buffered in the RAN 302 or the UE, the RAN 302 may transfer the corresponding error to the SMF 305 based on the packet error rate or FEC repair packet request information, and the SMF 305, which has received the information, may instruct the UPF entity 304 to stop buffering and transfer the FEC repair packet that has been buffered separately to the UPF entity 304.

The RAN, which has received the buffered FEC repair packet through the above process, may transmit, to the UE, the FEC source packet with the error and the FEC repair packet together.

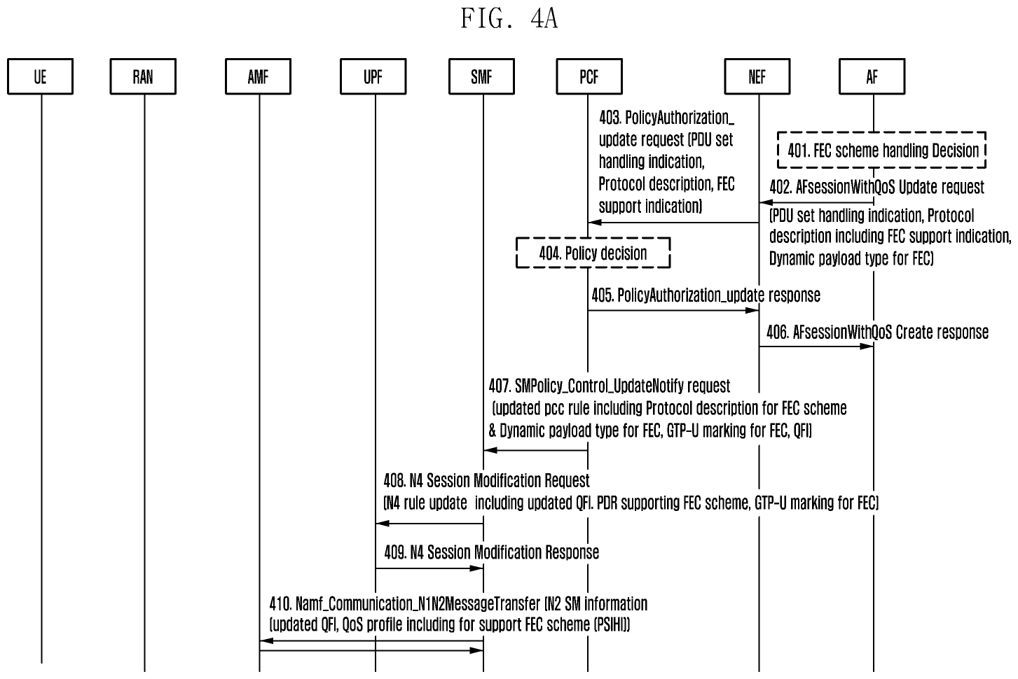

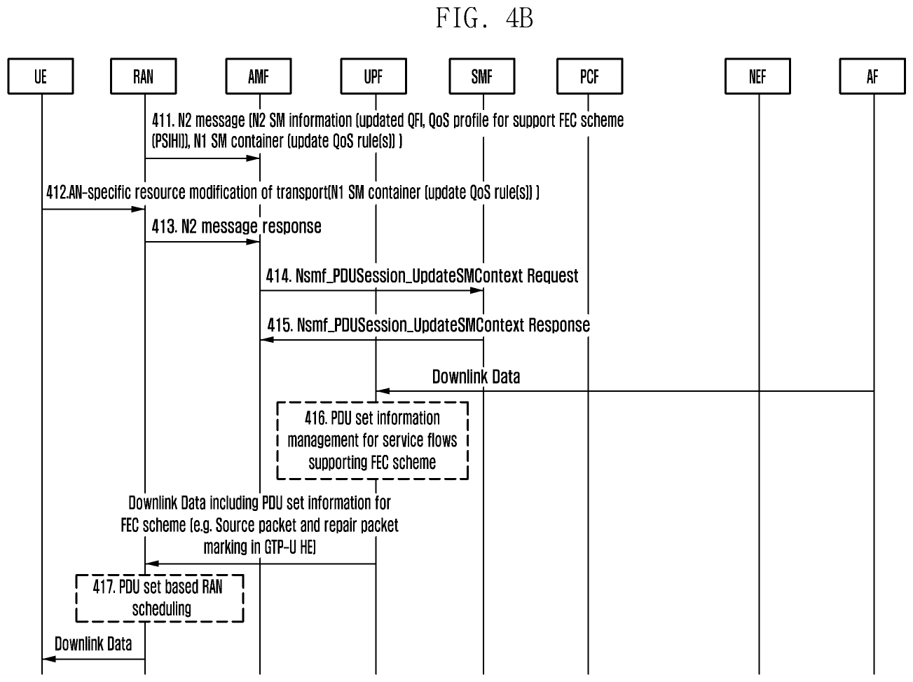

FIGS. 4A and 4B illustrate a method for transferring information for supporting scheduling for a service that transmits a packet created based on FEC using a protocol description including FEC-based packet creation support information transferred through the AF in a wireless communication system according to an embodiment.

Referring to FIG. 4A, in step 401, the AF may determine service support using the FEC scheme when a PDU set-based service is used according to a user's selection or service provider's policy. In this case, whether to apply the FEC scheme for each PDU set may be determined for each packet according to the importance of the PDU set even in the same media type (e.g., Video, Audio, Text, etc.), and information about whether to apply the FEC scheme for each PDU set may be included in the protocol description by marking an FEC support indication.

In step 402, the AF may transmit FEC scheme-based service support information, such as an FEC support indication to be used when supporting an FEC scheme-based service to the NEF based on the matters determined in step 401, and a protocol description including mapping information of FEC source packet and FEC repair packet, and receive a response. The FEC scheme handling-related information may be included in an AF session-related QoS requirements (AFsessionWithQoS) message transferred from the AF to the NEF entity.

The FEC scheme handling-related information per PDU set may be constituted with a protocol descriptor including FEC support information, such as an FEC handling indication or FEC support indication for each PDU set, and mapping information of each FEC source packet and FEC repair packet, within the AF session-related QoS requirements request message.

In step 403, the NEF may transfer FEC handling information to the PCF using a Policy Authorization message when supporting a service using the PDU set-based FEC scheme transferred from the AF. If a separate policy authorization service process has not been performed through an existing service, the NEF may transfer, to the PCF, the service-related FEC handling support information transferred through a policy authorization creation (Npcf_PolicyAuthorization_Create) request message, or through a policy authorization update (Npcf_PolicyAuthorization_Update) request message if there is an existing service process created.

In step 404, when the PCF determines whether to accept the corresponding request based on the FEC support indication and FEC support information for supporting packet handling using the FEC scheme transferred from the AF, and then, is able to accept the service request using the corresponding FEC scheme, the PCF may make a policy decision by determining a PCC rule creation/update. In this case, the PCF may transfer, to the SMF, the indication for supporting packet handling using the FEC scheme transferred from the AF and the related FEC support information.

The PCF may recognize from the FEC scheme support indication transferred from the AF that the RAN performs separate scheduling processing based on the FEC source packet and FEC repair packet in the PDU set of packets in the corresponding service floor. In support of this, the PCF may create the PDU set QoS profiles of packets transferred in the service floor using the FEC scheme based on the protocol descriptor or predefined information and include the created PDU set QoS profiles when creating or updating the PCC rule.

The UPF may perform PDU set information creation for the FEC source packet and FEC repair packet in service data flow that do not receive the PDU set information supporting the FEC scheme including the FEC source packet and FEC repair packet distinguishment information in the extension header of packet transferred from the AS. The UPF may receive the FEC-related information for creating the PDU set information of packet utilizing the PDU set-based FEC scheme from the AF through protocol description as in steps 402 and 403.

In steps 405 and 406, the PCF may notify the NEF and AF through a policy authorization update request and an AF session-related requirement update request message response that the service-related policy update request utilizing the PDU set-based FEC scheme has been accepted based on the service requirement transferred from the AF through operations 402 and 403.

In step 407, the PCF may transfer, to the SMF, through a session policy control update notification (Npcf_SMPolicyControl_UpdateNotify) request message, updated PCC rules including QoS information that is updated based on the PDU set QoS profile including indication that considers errors in packets within the PDU set, such as PDU set integrated handling indication for supporting services utilizing PDU set-based FEC scheme on the RAN, and FEC scheme support related information. The process of marking the PDU set information in the GTP-U extension header when the corresponding PDU set information is included in the header extension field of the corresponding packets in the UPF, for creating the PDU set information based on the protocol descriptor information transferred from the AF when one or more pieces of the PDU set information is not transferred through the packet extension header, and RTP header and confirmation header distinguishment information to be referenced for creating the corresponding PDU set information, and the like.

In step 408, the SMF may transfer packet handling information utilizing the PDU set-based FEC scheme to the UPF, including an information detection rule for FEC source and repair packets in the PDU set for service support utilizing the PDU set-based FEC scheme received through the PCF in step 406 (information for distinguishing FEC source packets and FEC repair packets in the PDU set, etc.) and FEC support related parameters (PDU set information related to FEC repair packets and information about FEC source packets in the PDU set, etc.), to the UPF through an N4 session modification request message. In step 409, the SMF may receive a response from the UPF. The N4 session modification request message may include a packet detection rule (PDR).

In step 410, the SMF may transfer N2 SM information and N1 SM container including PDU set QoS profile, etc. including updated QFI and QoS rule, PDU set integrated handling indication (PSIHI) information, etc. using QoS information of service floor to which PDU set-based FEC scheme is applied based on the PCC rule transferred from the PCF in step 407, to the AMF through an N1N2 message transfer (Namf_Communication_N1N2MessageTransfer) message.

Referring to FIG. 4B, in step 411, the AMF may receive the N2 SM information and N1 SM container including updated QFI and QoS rule, PDU set QoS profile, etc., for supporting service utilizing PDU set-based FEC scheme transferred in step 410, from the RAN using an N2 message

In step 412, the RAN may receive from the UE an N1 SM container including updated QoS rules, etc., to support a service utilizing the PDU set-based FEC scheme.

In step 414 and 415, PDU session update procedure is performed between the AMF and the SMF.

In step 416, the UPF may detect the PDU set information in an RTP packet header extension field transferred from the AS in the DN to the UPF through an N6 section. The UPF may mark the detected PDU set information in the GTP-U extension header and transfer the same to the RAN. Specifically, the PDU Set information utilizing the FEC scheme may be constituted with at least one of the PDU set-related information, such as a PDU set sequence number (SN), an end PDU of the PDU set, a PDU set size in bytes, a PDU SN within a PDU set, and a PDU set importance. Additionally, the PDU set information utilizing FEC scheme may be constituted to include at least one of FEC scheme-related information, such as FEC source packet and FEC repair packet distinguishment information, PDU set sequence information related to FEC repair packet, or sequence information of FEC source packet within PDU set.

When the PDU set information in the packet extension header in step 416 includes FEC source packet and FEC repair packet distinguishment information and FEC source packet information related to FEC repair packet, the UPF may mark this in the GTP-U extension header and transfer the same. When the FEC-related information in the PDU set information in the packet extension header transferred from the AS is not transferred, the UPF may create the corresponding information and transfer the information to the RAN through the GTP-U extension header.

In step 417, when a congestion situation occurs, the RAN may perform a basic scheduling operation based on the PDU set importance information in the PDU set information, in the PDU set unit of the packets within the QoS floor, based on the PDU set QoS profile including the PSIHI transferred in step 411 and the PDU set information supporting FEC. Additionally, in a service using the FEC scheme, the RAN may perform the scheduling operation based on the FEC source or FEC packet information for packets having the same PDU set importance.

FIGS. 5A and 5B illustrate a method for supporting an RAN scheduling operation according to a RAN congestion situation during service use using a PDU set-based FEC scheme in a wireless communication system according to an embodiment.

Referring to FIG. 5A, in step 501, the AF may determine service support using a PDU-based FEC scheme according to a user's selection or service provider's policy.

In step 502, based on the matters determined in step 501, the AF may transmit, to the NEF, information related to FEC scheme handling in units of PDU sets, such as a PDU set handling indication to be used when supporting a PDU set-based service, an FEC support indication, and a protocol description including mapping information of FEC source and repair packets, and receive a response. The PDU set handling-related information may be included in an AF session-related QoS requirements (AFsessionWithQoS) message transferred from the AF to the NEF entity.

The information related to FEC scheme handling at the PDU set unit may include PDU set handling related information, such as a PDU set handling indication in the AF session-related QoS requirement request message, codec of packets for each media type, sampling rate, media constitution type within the service floor (Group_RTP_Bundle), whether PDU set information for packets within the corresponding service floor is provided from the AS (PDU set information support indication), etc. In addition, the information may be constituted with a protocol descriptor including FEC support information, such as FEC scheme handling indication for each PDU set, mapping information for each FEC source packet and FEC repair packet, etc.

In step 503, the NEF may transfer FEC support related information including FEC support indication and mapping information of FEC source and repair packet to be used when supporting a service utilizing the PDU set-based FEC scheme transferred from the AF, or FEC information creation and related parameters, to the PCF using a policy authorization (PolicyAuthorization) message. The NEF may transfer, to the PCF, the service related FEC support information transferred through a policy authorization creation (Npcf_PolicyAuthorization_Create) request message if a separate policy authorization service process has not been performed, or through a policy authorization update (Npcf_PolicyAuthorization_Update) request message if an existing service process has been created. In addition, the NEF may request reporting of the corresponding service event through a policy authorization subscription (Npcf_PolicyAuthorization_Subscribe) request message to receive messages related to service-related reporting events utilizing the FEC scheme generated from the PCF.

To request a service utilizing the PDU set-based FEC scheme of the corresponding service floor, the AF may include the PDU set handling indication and related information for packet handling based on existing PDU sets, such as codec, sampling rate, packet payload type, protocol information (e.g., RTP, SRTP etc.), media type (e.g., video, audio etc.) of packets for each media type in the protocol descriptor and transfer the indication and related information to the PCF. In addition, to utilize the FEC scheme, the AF may additionally include FEC support information, such as FEC support indication, information of FEC source packets associated with FEC repair packets, and FEC payload format in the protocol descriptor and transfer the same to the PCF.

In step 504, the PCF makes a policy decision including determining whether to accept the corresponding request based on the FEC support indication and FEC support information for supporting packet handling using the FEC scheme transferred from the AF. When the service request using the corresponding FEC scheme is acceptable, the PCF determines to create/update a PCC rule. In this case, the PCF may include a protocol descriptor including the FEC support indication and related FEC support information for requesting support for packet handling using the FEC scheme transferred from the AF in the PCC rule and transfer the same to the SMF.

The PCF may recognize through the FEC support indication transferred from the AF that not all packets in the corresponding QoS floor may be transferred to the RAN, and that even when some packets are lost or missed, the RAN should be notified to drop the PDU set or not to process the PDU set separately during scheduling. For example, when using a PDU set-based service, the PCF may separately configure the error value of packets in the corresponding PDU set through PSER and transmit the configured error value by including the same in the PDU set QoS profile. In this case, even if the packets in the corresponding PDU set are lost more than the PSER value and transferred to the RAN, it is assumed that the UE side may restore the corresponding lost packets in the PDU set using the FEC scheme without dropping the entire PDU set, and transmission of the PDU set including the lost packets may be determined.

As described above, the PCF may notify the RAN that some packets in the PDU set are not transferred by adding PSIHI information to the PSU set QoS profile and may determine whether to add the corresponding information through the FEC support indication transferred through the AF. In addition, the UPF operation for distinguishing the FEC source and repair packets to support separate scheduling processing based on FEC source packets and FEC repair packets for packets in the service floor utilizing the corresponding FEC scheme may be included when creating or updating the PCC rule. When the UPF does not receive the PDU set information that supports the FEC scheme including FEC source packet and FEC repair packet distinguishment information through the extension header of the packet transferred from the AS, the UPF may perform creation of the PDU set information including the FEC source packet and FEC repair packet distinguishment information.

In step 505 and 506, the PCF may notify the NEF and AF through a policy authorization update request and an AF session related requirement update request message response that the service related policy update request utilizing the PDU set-based FEC scheme based on the service requirement transferred from the AF through steps 502 and 503 has been accepted.

In step 507, the PCF may transfer, to the SMF, through a session policy control update notification (Npcf_SMPolicyControl_UpdateNotify) request message, updated PCC rules including QoS information that is updated based on the PDU set QoS profile including indication that considers errors in packets within the PDU set, such as PSIHI for supporting services utilizing PDU set-based FEC scheme on the RAN, and FEC scheme support related information; the process of marking the PDU set information in the GTP-U extension header when the PDU set information is included in the header extension field of the corresponding packets in the UPF; the operation for creating the PDU set information based on the protocol descriptor information received from the AF when one or more pieces of PDU set information is not transferred through the packet extension header; and RTP header and confirmation header distinguishment information to be referenced for creating the corresponding PDU set information, FEC payload type, and the like.

In step 508, the SMF may transfer information for N4 rule update, including an information detection rule for FEC source and repair packets in the PDU set for service support utilizing the PDU set-based FEC scheme received through the PCF in step 507 (information for distinguishing FEC source packets and FEC repair packets in the PDU set, etc.) and FEC support-related parameters (PDU set information related to FEC repair packets and mapping information of FEC source packets in the PDU set, etc.), to the UPF through an N4 session modification request message. In step 509, the SMF may receive a response from the UPF.

In step 510, the SMF may transfer N2 SM information and N1 SM container including PDU set QoS profile, etc. including updated QFI and QoS rule, PSIHI information, etc. using QoS information of service floor to which PDU set-based FEC scheme is applied based on the PCC rule transferred from the PCF in step 507, to the AMF through an N1N2 message transfer (Namf_Communication_N1N2MessageTransfer) message.

In step 511, the AMF may transfer the N2 SM information and N1 SM container including updated QFI and QoS rule, PDU set QoS profile, etc., for supporting service utilizing PDU set-based FEC scheme transferred in step 510, to the RAN using an N2 message.

In step 512, the RAN may transfer to the UE the N1 SM container including updated QoS rules, etc., to support a service utilizing the PDU set-based FEC scheme.

Referring to FIGS. 5A and 5B, in steps 513 to 515, the RAN may transfer congestion information through the N2 SM information. When the congestion information is included in the QoS monitoring or GTP-U extension header in the RAN and transferred, the N2 SM information transferred in step 513 may not include the congestion information.

In step 516, the SMF may recognize or identify that a congestion situation occurs in the RAN based on the congestion information transferred through the above operation, separate QoS monitoring reporting information, or the like. The SMF may determine a buffering operation of FEC repair packets among the packets in a service utilizing the FEC scheme to reduce the congestion situation transferred to the RAN. The SMF may know in advance whether the buffering operation may be performed in the UPF by the network operator's configurations, etc. When the UPF does not support the buffering operation, the SMF may support the corresponding operation. The SMF may additionally consider buffering of FEC sources and FEC repair packets with low PDU set importance according to information such as congestion level in the congestion information. For example, a PDU set constituted with I, B, and P frames may be created or defined in a QoS floor transferring video data. In this case, when the packets in the PDU set related to the I-frame are configured to the highest priority, when the congestion level of the congestion information in the RAN is very high, buffering for the PDU sets constituting the B and P frames with low priorities may be determined. In a service using the PDU set-based FEC scheme, the FEC source packets of the PDU set of the I-frame with the highest priority are transmitted, and buffering may be determined for the FEC repair packets. Buffering may also be determined for the FEC source packets as well as the FEC repair packets of the B or P frames according to the congestion level information.

In step 517, the SMF may transfer information for updating the N4 rule for buffering the FEC repair packets to the UPF through the N4 session modification request message based on the policy determination of step 516. In step S181 the SMF may receive a response from the UPF. The information for the N4 rule update may include the FAR including the BAR and payload format information capable of detecting the corresponding FEC repair packet. In this case, when the FEC repair packet is linked with an FEC source packet per PDU set, such as when the FEC repair packet is not created as a source packet between different PDU sets, and when the PDU set information that is the last packet in the PDU set is transferred from the AS through a packet extension header or recognized based on information in the packet header, the SMF may request the UPF to transfer the corresponding information. Alternatively, the SMF may assume that the corresponding PDU sets are transmitted within a certain period of time based on the PDU set delay budget and determine that the transmission of the corresponding PDU set is completed after the PDU set delay budget configuration value. The PDU set delay budget may be included in the PDU set QoS profile and transferred from the PCF to the SMF. Based on the above information, the SMF may request the UPF to discard the FEC repair packet buffered therein.

For example, when the FEC source packets in the PDU set related to the FEC repair packet have been successfully transmitted to the RAN or UE, but no separate PSER, etc. are detected, all FEC source packets in the PDU set have been successfully transmitted to the RAN, the SMF may determine to remove the related FEC repair packets buffered in the UPF. Whether the FEC source packets in the PDU set received from the RAN are lost may be transferred to the SMF through QoS monitoring reporting in the UPF through QoS monitoring related to PER or PSER, or by transmitting packet/PDU set error information including a separate PER or PSER from the RAN through N2 SM information. The SMF may determine whether the packets in the PDU set received from the RAN are in error through the PDU set error information transferred through the UPF or RAN.

In step 519, the UPF may first detect PDU set information in an RTP packet header extension field transferred from the AS in the DN to the UPF through an N6 section. The UPF may mark the detected PDU set information in the GTP-U extension header and transfer the same to the RAN. Specifically, the PDU set information utilizing the FEC scheme may be constituted with at least one of PDU set related information, such as a PDU set SN, an end PDU of the PDU set, a PDU set size in bytes, a PDU SN within a PDU Set, and a PDU set importance. The PDU set information utilizing FEC scheme may additionally be constituted to include at least one of FEC scheme-related information, such as distinguishment information of FEC source packet and FEC repair packet, PDU set sequence information related to FEC repair packet, or sequence information of FEC source packet within PDU set. In addition, based on BAR information for performing buffering transferred to the UPF through step 517, the UPF may buffer FEC source and repair packets according to the importance of FEC repair packet or PDU set and may not transfer the corresponding packets to the RAN.

When the PDU set information in the extension header of the packet includes the distinguishment information of FEC source packets and FEC repair packets, and the information of FEC source packets associated with FEC repair packets, the UPF may mark the PDU set information in the GTP-U extension header and transfer the same. When the FEC-related information in the PDU set information in the packet extension header transferred from the AS is not transferred, the UPF may create the corresponding information and transfer the same to the RAN through the GTP-U extension header.

In step 520, the RAN may determine whether the FEC source packets in the PDU set are lost based on the PDU set information and PDU set QoS profile transferred in step 511. If a loss has occurred when receiving the FEC source packet in the PDU set, the RAN may determine whether to create PDU set error information including the PDU set error rate, sequence information of the packet in which the error has occurred in the PDU set, the corresponding PDU set information, and the like.

In steps 521 to 523, when the RAN recognizes a lost packet among the FEC source packets in the received PDU set, the RAN may include the corresponding PDU set error information in the N2 SM information and transfer the same to the SMF through the AMF. If the QoS-related requirements transferred from the AF to the PCF include a QoS monitoring requirement for the PDU set error rate, the PCF may create a PCC rule including the QoS monitoring requirement related to the PDU set error information including the PDU set error rate and transfer the same to the SMF. The SMF may transfer the QoS monitoring operation for the corresponding PDU set error information to the UPF through an N4 rule update, etc., and may request the UPF to report the corresponding QoS monitoring. When the PDU set error information may be transferred to the SMF through the QoS monitoring process, operations 521 to 523 may be omitted.

In step 524, the SMF may transmit the FEC repair packet buffered in the UPF, to the UPF, after receiving the PDU set error information including the PSER and PDU set related information in which the error has occurred, transferred from the RAN. In step 525, the SMF may receive a response from the UPF. The SMF may transfer the updated FAR including the buffering status change information to the UPF through the N4 rule update. The UPF, which has received the changed buffering status from the SMF, may transfer the buffered FEC repair packet to the RAN.

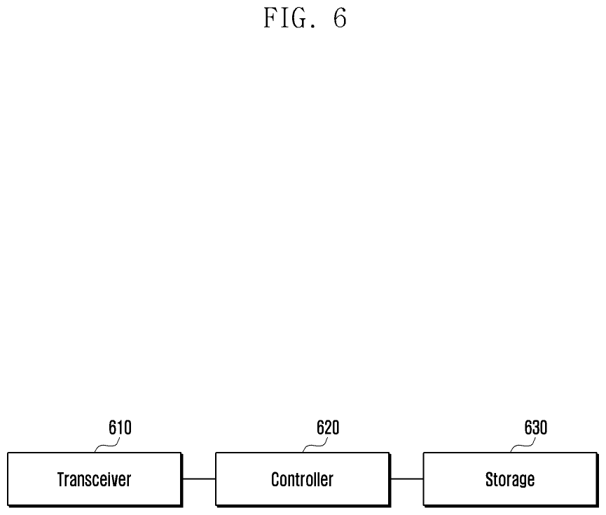

FIG. 6 illustrates a structure of a UE according to an embodiment.

Referring to FIG. 6, the UE may be constituted to include a transceiver 610, a controller 620, and a storage 630. The controller may be defined as a circuit, an application-specific integrated circuit, or at least one processor.

The transceiver 610 may transmit/receive a signal to/from another network entity. The transceiver 610 may receive system information from the BS, and receive a synchronization signal or a reference signal.

The controller 620 may control the overall operation of the UE according to an embodiment proposed by the disclosure. For example, the controller 620 may control signal flow between blocks to perform the operation according to the methods described herein. Specifically, the controller 620 may control an operation of receiving media data from a RAN of a communication system according to an embodiment and applying an FEC scheme to the received media data.

The storage 630 may store at least one piece of information transmitted and received through the transceiver 610 and information generated through the controller 620. For example, the storage 630 may store media files related to metaverse or extended reality.

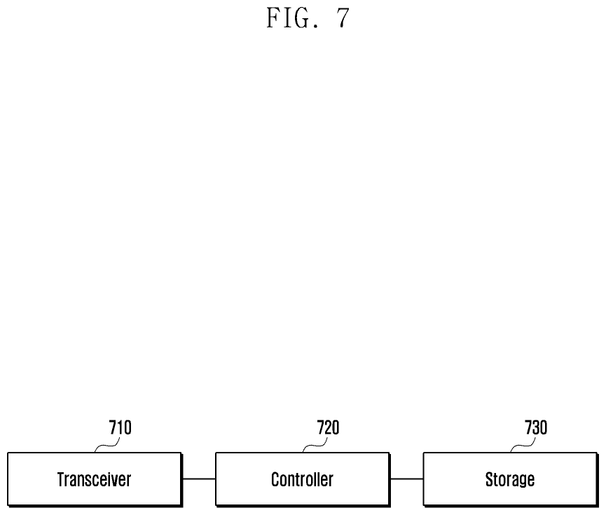

FIG. 7 illustrates a structure of a network entity according to an embodiment.

Referring to FIG. 7, the network entity may be constituted as one of various types of network entities disclosed herein and may be constituted as an AMF, UPF, SMF, PCF, NEF, AF, AS, and the like.

The transceiver 710 may transmit/receive a signal to/from another network entity. The transceiver 710 may receive an FEC source packet or an FEC repair packet from another network entity.

The controller 720 may control the overall operation of the network entity according to an embodiment proposed by the disclosure. For example, the controller 720 may control signal flow between blocks to perform the operation according to the methods described herein. Specifically, the controller 720 performs packet processing in units of PDU sets in a communication system as described herein and may control a method provided herein to apply the FEC scheme.

The storage 730 may store at least one piece of information transmitted and received through the transceiver 710 and information generated through the controller 720. For example, the storage 730 may store an FEC source packet or an FEC repair packet.

Methods as described herein may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within an electronic device. The at least one program may include instructions that cause the electronic device to perform the methods disclosed in the specification.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, the program may be stored in a memory formed by any combination of some or all of them. Each constituent memory may be included in plural.

The programs may be stored in an attachable storage device which may access the electronic device through communication networks, such as the Internet, Intranet, local area network (LAN), Wide LAN (WLAN), and storage area network (SAN) or a combination thereof. Such a storage device may access a device performing the embodiments of the disclosure via an external port. A separate storage device on the communication network may access a device performing the embodiment of the disclosure.

Herein, each block of the flowchart illustrations, and combinations of blocks in the flowchart illustrations, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block(s). These computer program instructions may also be stored in a computer usable or computer-readable memory that may direct a computer or other programmable data processing apparatus to function in a particular manner, such that the instructions stored in the computer usable or computer-readable memory produce an article of manufacture including instruction means that implement the function specified in the flowchart block(s). The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block(s).

Each block may represent a module, segment, or portion of code, which includes one or more executable instructions for implementing the specified logical function(s). It should also be noted that in some alternative implementations, the functions noted in the blocks may occur out of order. For example, two blocks shown in succession may be executed substantially concurrently or in the reverse order, depending upon the functionality involved.

Herein, the unit refers to a software element or a hardware element, such as a field programmable gate array (FPGA) or an application specific integrated circuit (ASIC), which performs a predetermined function. However, the unit does not always have a meaning limited to software or hardware. The unit may be constituted either to be stored in an addressable storage medium or to reproduce one or more processors. Therefore, the unit includes components such as software components, object-oriented software components, class components, and task components, processes, functions, properties, procedures, sub-routines, segments of a program code, drivers, firmware, micro-codes, circuits, data, database, data structures, tables, arrays, and parameters. The components and functions provided by the unit may be either combined into fewer components and a unit or divided into additional components and a unit. The components and units may be implemented to reproduce one or more central processing units (CPUs) within a device or a security multimedia card. A unit may include one or more processors.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a session management function (SMF) in a communication system, the method comprising:
receiving, from a policy control function (PCF), a policy and charging control (PCC) rule including a protocol descriptor that indicates support of a protocol data unit (PDU) set-based forward error correction (FEC);
transmitting, to a user plane function (UPF), packet handling information including detection rule information for distinguishing an FEC source packet and an FEC repair packet in the PDU set-based FEC; and
transmitting, to an access and mobility management function (AMF), a quality of service (QoS) profile including a QoS rule updated based on the PCC rule.

2. The method of claim 1, further comprising:
receiving, from the AMF, congestion information about a congestion situation occurring in a radio access network (RAN); and
determining a buffering operation for the FEC source packet or the FEC repair packet based on the congestion information.

3. The method of claim 2,
wherein determining the buffering operation is to determine the FEC source packet or the FEC repair packet to which the buffering operation is to be applied based on priority of the FEC source packet and the FEC repair packet.

4. The method of claim 2,
wherein, when the buffering operation is able to be performed in the UPF, a buffering action rule (BAR) is transmitted to the UPF, and
wherein, when the buffering operation is unable to be performed in the UPF, the buffering operation is performed on the SMF.

5. The method of claim 1,
wherein one FEC repair packet corresponds to one or more FEC source packet blocks.

6. A method performed by a user plane function (UPF) in a communication system, the method comprising:
receiving, from a session management function (SMF), a packet handling information including detection rule information for distinguishing a forward error correction (FEC) source packet and a FEC repair packet in a protocol data unit (PDU) set;
receiving, from an application server (AS), downlink data; and
transmitting, to a radio access network (RAN), information about whether a packet included in the downlink data corresponds to any one of the FEC source packet and the FEC repair packet and association information between the FEC source packet and the FEC repair packet by including the information about whether a packet included in the downlink data corresponds to any one of the FEC source packet and the FEC repair packet and the association information between the FEC source packet and the FEC repair packet in a general packet radio service tunneling protocol-user plane (GTP-U) header of each packet.

7. The method of claim 6, further comprising:
receiving, from the SMF, a buffering action rule (BAR) related to determination of buffering of the packet;
determining whether to perform a buffering operation for the packets included in downlink data based on the BAR; and
performing the buffering operation.

8. The method of claim 6,
wherein the PDU set-based scheduling in the RAN is performed based on FEC source packet information or FEC repair packet information.

9. A session management function (SMF) operating in a communication system, the SMF comprising:
a transceiver; and
a controller,
wherein the controller is configured to:
receive, from a policy control function (PCF), a policy and charging control (PCC) rule including a protocol descriptor that indicates support of a protocol data unit (PDU) set-based forward error correction (FEC),
transmit, to a user plane function (UPF), packet handling information including detection rule information that distinguishes FEC source packets and FEC repair packets in the PDU set-based FEC, and
transmit, to an access and mobility management function (AMF), a quality of service (QOS) profile including a QoS rule updated based on the PCC rule.

10. The SMF of claim 9, wherein the controller is further configured to:
receive, from the AMF, congestion information about a congestion situation occurring in a radio access network (RAN), and
determine a buffering operation for the FEC source packet or the FEC repair packet based on the congestion information.

11. The SMF of claim 10,
wherein the controller is further configured to determine the FEC source packet or the FEC repair packet to which the buffering operation is to be applied based on priority of the FEC source packet and the FEC repair packet.

12. The SMF of claim 10,
wherein the controller is further configured to transmit a buffering action rule to the UPF when the buffering operation is able to be performed in the UPF, and perform the buffering operation on the SMF when the buffering operation is unable to be performed in the UPF.

13. A user plane function (UPF) operating in a communication system, the UPF comprising:
a transceiver; and
a controller configured to:
receive, from a session management function (SMF), a packet handling information including detection rule information for distinguishing a forward error correction (FEC) source packet and a FEC repair packet in a protocol data unit (PDU) set,
receive, from an application server (AS), downlink data, and
transmit, to a radio access network (RAN), information about whether a packet included in the downlink data corresponds to any one of the FEC source packet and the FEC repair packet and association information between the FEC source packet and the FEC repair packet by including the information about whether a packet included in the downlink data corresponds to any one of the FEC source packet and the FEC repair packet and the association information between the FEC source packet and the FEC repair packet in a general packet radio service tunneling protocol-user plane (GTP-U) header of each packet.

14. The UPF of claim 13, wherein the controller is further configured to:
receive, from the SMF, a buffering action rule (BAR) related to a buffering determination of the packet,
determine whether to perform a buffering operation for the packets included in downlink data based on the BAR, and
perform the buffering operation.

15. The UPF of claim 13,
wherein the PDU set-based scheduling in the RAN is performed based on FEC source packet information or FEC repair packet information.
